(19) United States
(12) Patent Application Publication
(10) Pub. No.: US 2013/0169025 A1
(43) Pub. Date: Jul. 4, 2013

(54) APPARATUS FOR PREVENTING THE SKIDDING OF A VEHICLE PROVIDED WITH WHEELS

(71) Applicant: Thorvald Granström, Stockholm (SE)

(72) Inventor: Thorvald Granström, Stockholm (SE)

(73) Assignee: T Granstrom Konsult AB, Stockholm (SE)

(21) Appl. No.: 13/821,825

(22) PCT Filed: Sep. 14, 2011
(86) PCT No.: PCT/SE11/51113

§ 371 Date: Mar. 8, 2013

(30) Foreign Application Priority Data
Oct. 5, 2010 (SE) 1051043-6

(51) Int. Cl. B60B 15/26

(52) U.S. Cl. CPC B60B 15/263
USPC 301/44.4

(57) ABSTRACT

An apparatus (102; 202; 302) for preventing the skidding or sliding of a wheeled vehicle on a road surface (164), and the apparatus comprises an annular element (106; 206; 306) defining a first central axis (a-a, a3-a3) and having an outer wall (108; 308), the outer wall extending around the first central axis and facing away from the first central axis and being provided with friction means (110; 310) arranged to engage the road surface, and mounting means (116; 216; 316) for mounting the element to one of the rotatable wheels (116; 216; 316) of the vehicle and around a second central axis (b-b, b3-b3) defined by the mounting means, the mounting means being arranged to be attached to the wheel so that the second central axis is substantially collinear with an axis of rotation (c-c; c3-c3) defined by the wheel and so that the mounting means and the element are rotatable, and the element is movable in a direction about the first central axis in relation to the mounting means, wherein the mounting means and the element comprise complementary guide means movable in relation to one another. When the wheel skids or slides on the road surface, the guide means are arranged move at least one section (162; 362) of the element away from the second central axis to force the friction means of the at least one element section (162; 362) towards braking engagement with the road surface. When the wheel rolls on the road surface, the guide means are arranged to rotate the element about the first central axis. A vehicle wheel comprising the above-mentioned apparatus.

### TECHNICAL FIELD

The present invention relates to an apparatus for preventing the skidding or sliding of a wheeled vehicle on a road surface. The apparatus comprises an annular element defining a first central axis and having an outer wall, the outer wall extending around the first central axis and facing away from the first central axis and being provided with friction means arranged to engage the road surface, and mounting means for mounting the element to one of the rotatable wheels of the vehicle and around a second central axis defined by the mounting means, the mounting means being arranged to be attached to the wheel so that the second central axis is substantially collinear with an axis of rotation defined by the wheel and so that the mounting means and the element are rotatable, and the element is movable in a direction about the first central axis in relation to the mounting means. Further, the present invention relates to a vehicle wheel for the rotatable mounting to a vehicle, the vehicle wheel comprising at least one apparatus of the above-mentioned sort.

### BACKGROUND OF THE INVENTION

During winter conditions of the road, vehicles are often provided with studded tires, i.e. tires provided with studs, for preventing the skidding or sliding of a wheeled vehicle on a road surface covered with ice or snow. However, during the season or period when dubbed tires are used, it is common that the same wheeled vehicle is driven both on road surfaces covered with ice or snow and on road surfaces without both ice and snow. The usage of dubbed tires on a road surface without snow or ice puts wear on the road surface, tears off particles of the road surface and puts wear on the studs per se. Particles torn off of the road surface may be an environmental problem and a health hazard. Wear on the road surface and on studs may also occur on roads covered with snow or ice. Changing between studded tires and tires without studs every time the road surface changes between an ice, or snow, covered road surface and a road surface without ice is tiresome, as a vehicle may be confronted with shifting conditions of the road surface several times per winter season, even several times per month or week, or more often.

U.S. Pat. No. 2,273,663 discloses en extra anti-skid wheel mounted to the inside of the regular vehicle wheel. The anti-skid wheel is lowered and raised, respectively, in a vertical direction between a lower position and an upper position by manually operating an angled arm. In the lower position the anti-skid wheel is said to enter an engagement with the road surface.

U.S. Pat. No. 2,474,939 describes a carrier with extensible and retractable studs or grouters, the carrier being arranged to be mounted to a vehicle wheel

U.S. Pat. No. 5,029,945 discloses an apparatus for attachment to the regular vehicle wheel. The apparatus has extensible and retractable studs controlled by means of a control unit provided in the apparatus.

U.S. Pat. No. 3,039,551 describes an extra wheel having a smaller diameter than the regular vehicle wheel to which the extra wheel is mounted. The extra wheel is vertically lowered and brought into contact with the road surface by operating and guiding a guide element, e.g. by means of a hydraulic cylinder.

### THE OBJECT OF THE INVENTION

The object of the present invention is to prevent the skidding or sliding of a wheeled vehicle on a road surface. Another object is to prevent the skidding or sliding of a wheeled vehicle on a slipper or icy road surface while minimizing the wear on the road surface.

### SUMMARY OF THE INVENTION

The above-mentioned object of the present invention is attained by providing an apparatus for preventing the skidding or sliding of a wheeled vehicle on a road surface, and the apparatus comprises an annular element defining a first central axis and having an outer wall, the outer wall extending around the first central axis and facing away from the first central axis and being provided with friction means arranged to engage the road surface, and mounting means for mounting the element to one of the rotatable wheels of the vehicle and around a second central axis defined by the mounting means, the mounting means being arranged to be attached to the wheel so that the second central axis is substantially collinear with an axis of rotation defined by the wheel and so that the mounting means and the element are rotatable, and the element is movable in a direction about the first central axis in relation to the mounting means, wherein the mounting means and the element comprise complementary guide means movable in relation to one another, wherein, when the wheel skids or slides on the road surface the guide means are arranged to move at least one section of the element away from the second central axis to force the friction means of the at least one element section towards braking engagement with the road surface, and wherein, when the wheel rolls on the road surface, the guide means are arranged to rotate the element about the first central axis.

By means of the apparatus according to the present invention, an automatic control of the annular element, provided with friction means, between at least one first position or mode, in which the element and its friction means roll easily on the road surface without any braking engagement, and at least one second position or mode, in which the at least one element section and its friction means are forced towards and enter a braking engagement with the road surface. The automatic control between the at least one first and the at least one second position is effected by the conventional braking and skidding of the vehicle wheel on the road surface. The user does not need to take any active measure after the installation of the apparatus in order to guide, or control, the element and its friction means between the at least one first and the at least one second position. The at least one first position may be a plurality of first positions, and the at least one second position may be a plurality of second positions. By means of the apparatus according to the present invention, an automatic vertical dislocation of the at least one element section towards the road surface may be achieved when the vehicle wheel skids, so that the at least one element section's friction means enter braking engagement with the road surface. When the vehicle wheel no longer skids, an automatic vertical dislocation of the at least one element section in a direction away from the road surface is attained, so that the at least one element section's friction means leave the braking engagement with the road surface and the element is rotated about the second central axis and rolls easily on the road surface. By braking engagement is meant that the friction means engage the road surface in such a manner that the friction between the friction means and the road surface prevents the sliding of the element on the road surface and therewith prevents the sliding of the vehicle wheel on the road surface. The mounting means may be arranged to be attached to the outside of the wheel or to the inside of the wheel, between the regular vehicle wheel and the main part of the wheel shaft connected to the vehicle wheel. The mounting means may also be arranged to be attached between two adjacent wheels and/or two wheels mounted to one another. The apparatus may be arranged to be provided between two adjacent wheels and/or two wheels mounted to one another. The mounting means may be attachable to the wheel so that the mounting means and the wheel are not movable in relation to one another. By means of the present invention, the friction means may comprise studs having longer projection in relation to studs of studded tires of prior art, which gives a more efficient braking when the conditions of the road is icy or slippery. Further, the risk of studs coming off is reduced by means of the apparatus of the present invention, as the studs are not continuously in firm engagement with the road surface. The apparatus according to the present invention achieves en efficient braking both in winter conditions of the road and wet conditions of the road, when there is a risk for aquaplaning. The apparatus according to the present invention may also enhance the function of an electronic anti-skid system, as the element automatically enters braking engagement for the wheel that is currently braked by the anti-skid system. By means of the invention the fuel consumption of the vehicle may be reduced as the material of the tire can be more adapted to reduce the fuel consumption without as high consideration of the braking performance, since the friction means enter braking engagement when braking. The guide means may also be called guide parts or guide elements. The road surface does not have to be a surface formed by a constructed road, but may be any surface on which the vehicle is driven. Thus, the road surface in this context can represent any surface on which the vehicle is driven. When the wheel skids or slides on the road surface the guide means may be arranged to radially move at least one section of the element away from the second central axis. Advantageously, the element has a larger diameter (rolling diameter) than the diameter of the vehicle wheel. The mounting means may be configured in many ways for the mounting to the vehicle wheel, e.g. with threaded pins and threaded holes, with bayonet attachments etc. Advantageously, the mounting means may be arranged to be attached to the wheel, e.g. to the wheel hub.

According to an advantageous embodiment of the apparatus according to the present invention, the complementary guide means are movable in relation to one another about the first central axis and in a radial direction. Thus, the complementary guide means are movable in relation to one another in the direction of rotation of the mounting means.

According to a further advantageous embodiment of the apparatus according to the present invention, the apparatus is characterized in that, when the wheel skids or slides on the road surface the guide means are arranged to move at least one element section located closest to the road surface. By means of this embodiment, the skidding or sliding of a wheeled vehicle on a road surface is prevented in an efficient manner.

According to another advantageous embodiment of the apparatus according to the present invention, when the wheel skids or slides on the road surface the guide means are arranged to limit the rotation of the element about the first central axis. By means of this limitation of the rotation of the element, the at least one element section's friction means are forced towards braking engagement with the road surface in an efficient manner.

According to yet another advantageous embodiment of the apparatus according to the present invention, the guide means are arranged to radially move the at least one element section away from the second central axis by moving the at least one element section about the first central axis in relation to the mounting means. In this context, radial direction is defined in relation to the first or the second central axis. By means of this embodiment, the at least one element section's friction means are forced towards braking engagement with the road surface in an efficient manner.

According to an advantageous embodiment of the apparatus according to the present invention, the element has an inner wall extending around the first central axis and facing the first central axis, wherein the mounting means comprises an outer wall extending around the second central axis and facing away from the second central axis, and wherein the outer wall of the mounting means and the inner wall of the element are provided with the guide means. By means of this embodiment, an efficient automatic guidance, or control, of the element between the at least one first position and the at least one second position is attained.

According to a further advantageous embodiment of the apparatus according to the present invention, the guide means comprise a plurality of pairs of guide members distributed about the first and the second central axis, respectively, the element being provided with one of the guide members of each pair, and the mounting means being provided with the other guide member of each pair, the guide members of each pair being movable in relation to one another and arranged to cooperate with one another. By means of this embodiment, the automatic guidance, or control, of the element between the at least one first position and the at least one second position is further improved.

According to another advantageous embodiment of the apparatus according to the present invention, the plurality of pairs of guide members is evenly distributed about the first central axis and the second central axis, respectively. By even distribution is meant that the plurality of pairs of guide members is located with substantially equal distances between the pairs about the first central axis. This provides an even guidance, or control, of the element between the at least one position and the at least one second position. Advantageously, the guide members are evenly distributed about the first central axis and the second central axis, respectively. Alternatively, the plurality of pairs of guide members may be unevenly distributed about the first and the second central axis, respectively, i.e. said plurality of pairs of guide members is located with different distances between the pairs about the first central axis. Uneven distribution can be advantageous to prevent resonance problems and reduce noise when driving, whereas even distribution facilitates the production and the assembly of the apparatus.

According to yet another advantageous embodiment of the apparatus according to the present invention, a first guide member of each pair comprises a first surface which forms at least one first angle with the tangential direction about the second central axis and forms at least one second angle with the radial direction. Radial direction and tangential direction in this context are related to the second central axis. By means of this embodiment and the angled first surface, the braking engagement increases gradually in strength as long as the vehicle wheel skids, since the longer distance the vehicle wheel skids the more the at least one element section and its friction means are displaced, in a gradual manner, in the direction towards the road surface. Hereby, the skidding and sliding of a wheeled vehicle on a road surface is prevented in an even more efficient manner.

According to an advantageous embodiment of the apparatus according to the present invention, a second guide member of each pair comprises a first surface which forms at least one first angle with the tangential direction about the second central axis and forms at least one second angle with the radial direction. By means of this embodiment, the above-mentioned gradual increase of the strength of the braking engagement is enhanced. Hereby, the skidding and sliding of a wheeled vehicle on a road surface is prevented in an even more efficient manner.

Advantageously, each first surface comprises a first surface portion and a second surface portion, the first surface portion being located further away from the first central axis and the second central axis, respectively, in relation to the second surface portion of the guide member.

According to a further advantageous embodiment of the apparatus according to the present invention, the first surfaces of a pair's first and second guide members are arranged to cooperate to move the at least one element section away from the second central axis. Hereby, the skidding and sliding of a wheeled vehicle on a road surface is prevented in an even more efficient manner.

According to another advantageous embodiment of the apparatus according to the present invention, the first guide member of each pair comprises a second surface which extends substantially radially. By means of this embodiment, the element is forced to rotate about the second central axis in an efficient manner when the vehicle wheel rolls on the road surface.

According to still another advantageous embodiment of the apparatus according to the present invention, the second guide member of each pair comprises a second surface which extends substantially radially. By means of this embodiment, the element is rotated about the second central axis in a further efficient manner when the vehicle wheel rolls on the road surface.

According to another advantageous embodiment of the apparatus according to the present invention, the second surface of each guide member on the element is arranged to cooperate with the second surface of a guide member on the guiding means to rotate the element about the first central axis. Hereby, the skidding and sliding of a wheeled vehicle on a road surface is prevented in an efficient manner.

According to an advantageous embodiment of the apparatus according to the present invention, the apparatus is characterized in that, when the wheel rolls on the road surface the guide means are arranged to rotate the element about the first central axis so that the first central axis is eccentric in relation to the second central axis, and in that, when the wheel skids or slides on the road surface the guide means are arranged to move the element and the first central axis in a direction towards the second central axis. By the first central axis being eccentric in relation to the second central axis is meant that the first central axis is not collinear with the second central axis. Hereby, the skidding and sliding of a wheeled vehicle on a road surface is prevented in an efficient manner.

According to a further advantageous embodiment of the apparatus according to the present invention, the mounting means is arranged to be provided in a tire included in the wheel of the vehicle. Hereby, the skidding and sliding of a wheeled vehicle on a road surface is prevented in an efficient manner.

According to another advantageous embodiment of the apparatus according to the present invention, the mounting means is integral with the tire. Hereby, the mounting of the apparatus to the wheel is facilitated, and the apparatus is not bulky.

According to yet another advantageous embodiment of the apparatus according to the present invention, the friction means comprise studs.

According to still another advantageous embodiment of the apparatus according to the present invention, the friction means comprise a high friction material different from the material of the wheel. Examples of high friction materials are well known to the skilled person.

The above-mentioned object of the present invention is also attained by providing a vehicle wheel for the rotatable mounting to a vehicle, the vehicle wheel comprising at least one apparatus for preventing the skidding or sliding of the vehicle on a road surface, wherein the apparatus comprises the features according to any of the claims 1 to 17, and/or the features included in any of the above-mentioned embodiments of the apparatus according to the present invention. Positive effects of the wheel according to the present invention and its embodiments correspond to the above-mentioned effects mentioned in connection with the apparatus according to the present invention and its embodiments. Advantageously, the vehicle wheel comprises a tire, such as a rubber tire, e.g. a tire that can be pressurized or be inflated with compressed air or gas.

The above-mentioned features and embodiments of the apparatus and the wheel, respectively, according to the present invention may be combined in various possible ways providing further advantageous embodiments.

Further advantageous embodiments of the apparatus and the wheel, respectively, according to the present invention and further advantages with the present invention emerge from the dependent claims and the detailed description of embodiments.

### BRIEF DESCRIPTION OF THE DRAWINGS

The present invention will now be described, for exemplary purposes, in more detail by way of embodiments and with reference to the enclosed drawings, in which:

FIG. 1 is a schematic exploded view of a first embodiment of the apparatus according to the present invention prepared to be mounted to the outside of a vehicle wheel;

FIG. 2 is a schematic exploded view of the embodiment of FIG. 1 prepared to be mounted to the inside of a vehicle wheel;

FIG. 3 is a schematic front view of a vehicle wheel provided with two apparatuses according to FIGS. 1 and 2;

FIG. 4 is a schematic perspective view of the vehicle wheel of FIG. 3 as viewed from the outside of the wheel;

FIG. 5 is a schematic perspective view of a the vehicle wheel of FIG. 3 as viewed from the inside of the wheel;

FIG. 6 is a schematic side view of the vehicle wheel and the apparatus of FIG. 1, partially in cross-section, while travelling without the wheel skidding or sliding;

FIG. 7 shows the section A-A of FIG. 6, without the wheel skidding or sliding;

FIG. 8 is a schematic side view of the vehicle wheel and the apparatus of FIG. 1, partially in cross-section, while travelling when the wheel skids or slides;

FIG. 9 is a schematic front view of the vehicle wheel and the apparatus of FIG. 1 while travelling when the wheel skids or slides;

FIG. 10 is a schematic exploded view of a second embodiment of the apparatus according to the present invention for the mounting in a tire of a vehicle wheel;

FIG. 11 is a view showing the apparatus of FIG. 10 mounted to the tire of the vehicle wheel;

FIG. 12 is a schematic exploded view of a third embodiment of the apparatus according to the present invention;

FIG. 13 is a schematic perspective view of the apparatus of FIG. 12 for the mounting to a vehicle wheel;

FIG. 14 is a schematic side view of a vehicle wheel provided with the apparatus of FIGS. 12 and 13, partially in cross-section, while travelling without the wheel skidding or sliding;

FIG. 15 is a schematic front view of the vehicle wheel and the apparatus of FIG. 14 while travelling without the wheel skidding or sliding;

FIG. 16 is a schematic side view of the vehicle wheel and the apparatus of FIGS. 12 and 13, partially in cross-section, while travelling when the wheel skids or slides;

FIG. 17 is a schematic front view of the vehicle wheel and the apparatus of FIG. 16 while travelling when the wheel skids or slides;

FIG. 18 is a schematic perspective view of a fourth embodiment of the apparatus according to the present invention to be mounted to two vehicle wheels;

FIG. 19 is a view of the apparatus of FIG. 18 mounted to the two vehicle wheels;

FIG. 20 is a schematic side view of the deice and the vehicle wheels of FIG. 19;

FIG. 21 shows the section A-A of FIG. 20;

FIG. 22 is an enlargement of the region B of FIG. 1; and

FIG. 23 is a schematic front view of the apparatus and the vehicle wheels of FIG. 19.

### DETAILED DESCRIPTION OF PREFERRED EMBODIMENTS

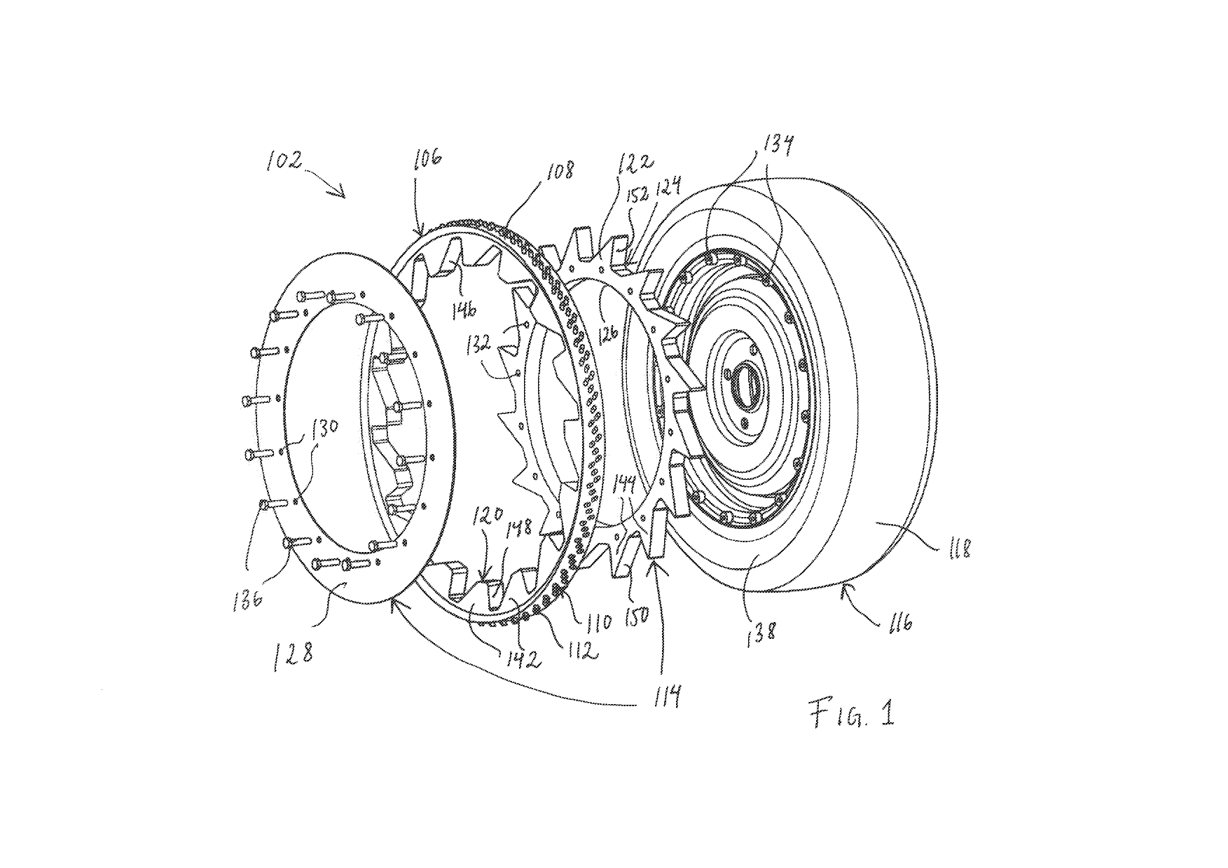

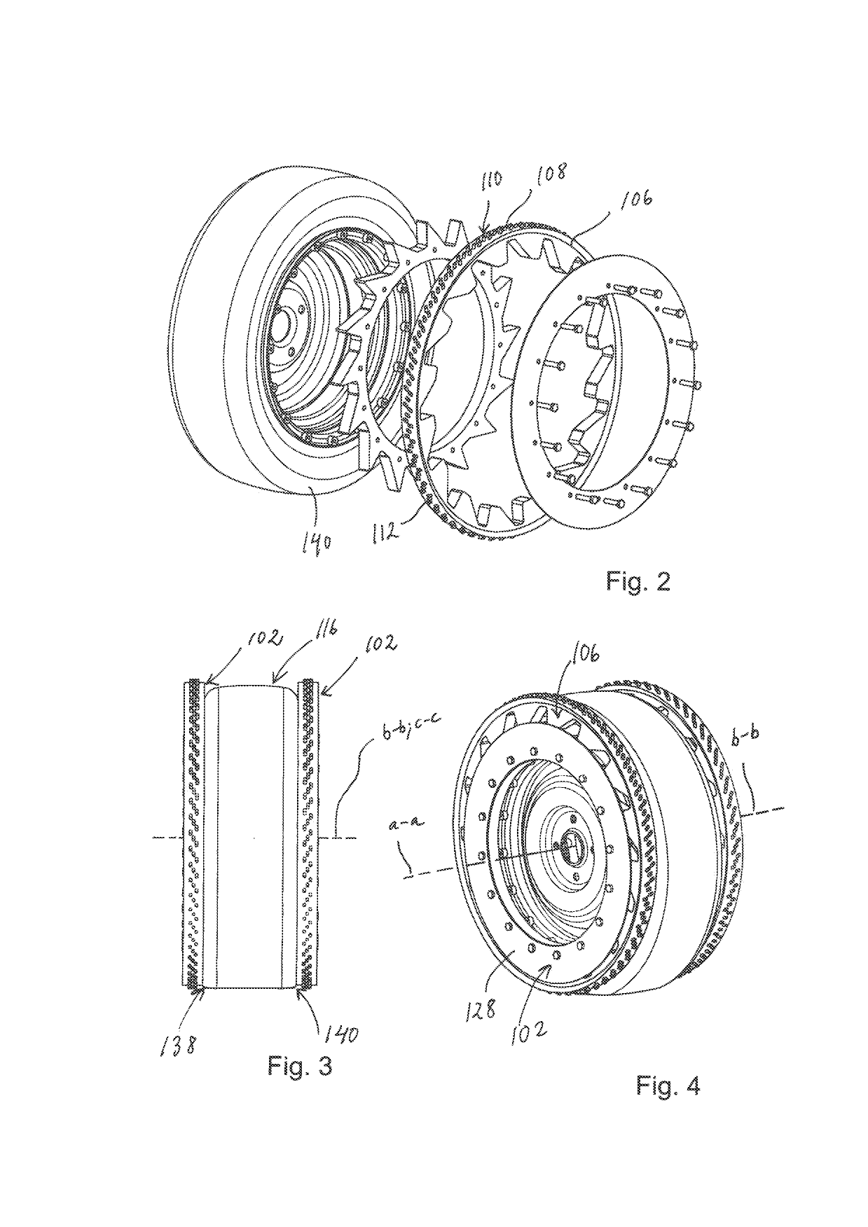

With reference to FIGS. 1-9, a first embodiment of the apparatus 102 according to the present invention for preventing the skidding or sliding of a wheeled vehicle on a road surface 164 (see FIG. 6) is schematically shown. The apparatus 102 comprises an annular element 106 made of a flexible material, such as plastic or rubber, or any other flexible material. The element 106 may e.g. be made of an annular steel band to which the below described first guide members and below described friction means are mounted. The annular element 106 may for this embodiment be described as an annular belt. The element 106 defines a first central axis a-a (see FIG. 4) and has an outer wall 108 extending around the first central axis a-a and facing away from the first central axis a-a. The outer wall 108 is provided with friction means 110 arranged to engage the road surface 164. In this embodiment the friction means comprise a plurality of studs 112 distributed on the outer wall 108 about the first central axis a-a. The studs 112 may be made of metal, hard plastic, or any other suitable material. The apparatus 102 comprises mounting means 114 for mounting the element 106 to one of the rotatable wheels 116 of the vehicle and around a second central axis b-b (see FIG. 4) defined by the mounting means 114. Advantageously, the wheel 116 is provided with a rubber tire 118 which is arranged to be pressurized and inflated with compressed air or gas in a conventional manner. The mounting means 114 is arranged to be attached to the wheel 116 so that the second central axis b-b is substantially collinear with an axis of rotation c-c defined by the wheel (see FIGS. 3 and 4) and so that the mounting means 114 and the element 106 are rotatable about the axis of rotation c-c. The element 106 is pivotable or movable in a direction about the first and second central axes a-a, b-b in relation to the mounting means 114. Instead of studs 112, the friction means 110 may comprise a high friction material different from the material of the wheel, more precisely, the material of the tire 118. The element 106 has an inner wall 120 extending around the first central axis a-a and facing the first central axis a-a.

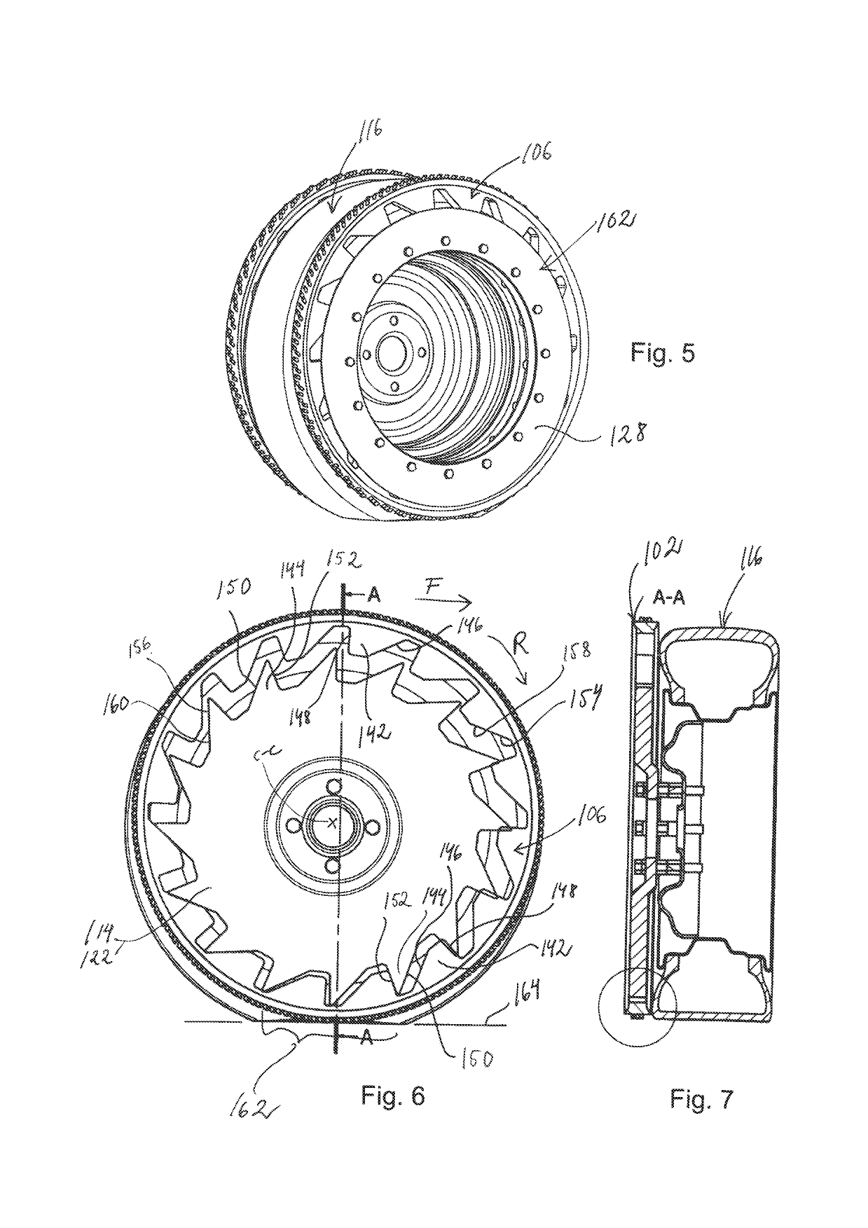

The mounting means 114 comprises an annular first mounting unit 122 comprising an outer wall 124 extending around the second central axis b-b and facing away from the second central axis b-b. The first mounting unit 122 also comprises an inner wall 126 extending around the second central axis b-b and facing the second central axis b-b. The mounting means 114 comprises an annular second mounting unit 128. The mounting means 114 is attachable to the wheel 116 by means of a plurality of through-holes 130, 132, which may be threaded, provided in the first and the second mounting unit 122, 128, a plurality of threaded recesses 134 provided in the wheel 116 and a plurality of threaded attachment members 136, e.g. bolts/screws. However, the mounting means 114 may be configured in a plurality of other manners for the attachment to the wheel 116. When the second mounting unit 128 is attached to the first mounting unit 122 and the wheel 116, these define an annular compartment, space or channel in which the element 106 is provided, and the annular compartment holds the element 106 in place by the fact that the annular compartment limits or restricts the dislocation of the element 106 in the direction of the extension of the second central axis b-b (lateral dislocation) and in a radial direction towards the second central axis b-b. FIGS. 3-5 show the wheel 116 provided with two mounted apparatuses 102, one apparatus 102 mounted to the outside 138 of the wheel, and the other apparatus 102 mounted to the inside 140 of the wheel. FIG. 3 schematically shows the vehicle wheel from the front, FIG. 4 schematically shows the vehicle wheel 116 as viewed from the outside 138 of the wheel 116, and FIG. 5 schematically shows the vehicle wheel 116 as viewed from the inside 140 of the wheel 116.

The mounting means 114 and the element 106 comprise complementary guide members movable in relation to one another and about the first and the second central axis a-a, b-b, respectively. The guide members comprise a plurality of pairs of guide members 142, 144 distributed about the first and the second central axis a-a, b-b, respectively. The element 106 is provided with a first guide member 142 of each pair, and the mounting means 114 is provided with a second guide member 144 of each pair, and the guide members 142, 144 of each pair are movable in relation to one another and are arranged to cooperate with one another. The inner wall 120 of the element is provided with the first guide members 142 of each pair and the outer wall 124 of the mounting means 114, which is provided in the first mounting unit 122, is provided with the second guide members 144 of each pair. Said plurality of pairs of guide members 142, 144 is evenly distributed about the first and the second central axis a-a, b-b, respectively.

The first guide member 142 of each pair has a first surface 146 which forms at least one first angle with the tangential direction about the first and the second central axis a-a, b-b, respectively, and forms at least one second angle with the radial direction, where the radial direction is related to the first and the second central axis a-a, b-b, respectively. The first guide member 142 of each pair has a second surface 148 which extends substantially radially. The second guide member 144 of each pair has a first surface 150 which forms at least one first angle with the tangential direction about the first and the second central axis a-a, b-b, respectively, and forms at least one second angle with the radial direction. The second guide member 144 of each pair has a second surface 152 which extends substantially radially. Each first surface comprises a first surface portion 154, 156 and a second surface portion 158, 160, where the first surface portion 154 of the first guide member 142 is located further away from the first and the second central axis a-a, b-b, respectively, in relation to the second surface portion 158 of the first guide member 142. The first surface portion 156 of the second guide member 144 is located further away from the first and the second central axis a-a, b-b, respectively, in relation to the second surface portion 160 of the second guide member 144.

The first and second guide members 142, 144 of each pair are arranged to cooperate, interact, with one another. When the wheel 116 skids or slides on the road surface the first and second guide members 142, 144 are arranged, by means of the cooperation of the first surfaces 146, 150 of the guide members 142, 144, to move at least one section 162 of the element 106 closest to the road surface 164 in relation to the mounting means 114 and away from the second central axis b-b and thus to drive the studs 112 of the at least one element section 162 towards braking engagement, or grip, with the road surface 164. The first and second guide members 142, 144 are arranged, by means of the cooperation of the first surfaces 146, 150 of the guide members 142, 144, to radially move the at least one element section 162 away from the second central axis b-b by moving the at least one element section 162 about the first central axis a-a in relation to the mounting means 114. When the wheel 116 skids or slides on the road surface the first surfaces 146, 150 are arranged to limit the rotation of the element 106 about the first central axis a-a. When the wheel 116 rolls on the road surface 164 the first and second guide members 142, 144 are arranged, by means of the cooperation of the second surfaces 148, 152 of the guide members 142, 144, to rotate the element 106 about the first central axis a-a.

With reference to FIGS. 6-7, the wheel 116 and the apparatus 102 are illustrated when the wheel 116 rolls on the road surface 164 during normal drive without the wheel 116 skidding or sliding in the direction of travel F of the vehicle. The wheel 116 and the apparatus 102 rotate in the direction of rotation R. As shown in FIG. 6, the second surfaces 148, 152 of the guide members 142, 144 abut one another at the lower portion of the wheel 116 closest to the road surface 164. The second surface 152 of the guide member 144 of the mounting means 114 can be described as forcing or pushing the second surface 148 of the guide member 142 of the element 106. The element 106 has a slightly larger diameter than the wheel 116 and the second surface 152 of the second guide member 144 can be described as “holding back” the second surface 148 of the first guide member 142 and thus holds back the element 106, as the element 106 with its larger diameter than the wheel 116 wants to roll “faster” than the wheel 116. In FIGS. 6 and 7, the element 106 rolls with the studs on the road surface without any braking engagement with the road surface, and the wear on the road surface and on the studs is minimized.

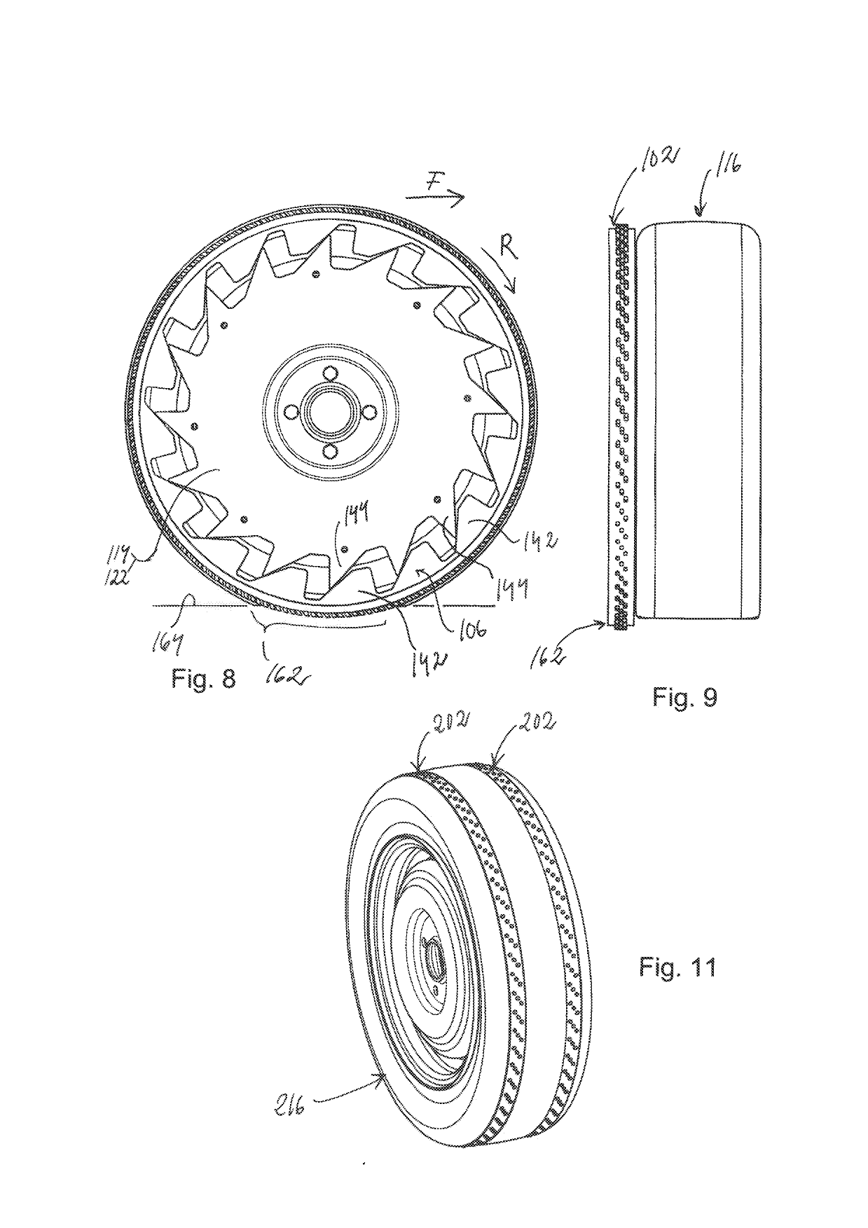

With reference to FIGS. 8-9, the wheel 116 and the apparatus 102 are shown when the wheel 116 skids or slides in the direction of travel F of the vehicle during braking. The movement of the wheel 116 and the mounting means 114 in the direction of rotation R is reduced or completely stops. However, the element 106 has a movement, or a faster movement, in the direction of rotation R, which results in that the first guide member 142 is moved in the direction of rotation R in relation to the second guide member 144. However, closest to the road surface, the movement of the first guide members 142 in the direction of rotation R is limited or restricted by means of the cooperation of the first surfaces 146, 150 of the guide members 142, 144. The first surfaces 146, 150 of the guide members 142, 144 distinctly abut one another in the lower part of the wheel in FIG. 8. The result is that the first guide members 142 closest to the road surface 164 are moved radially away from the second central axis b-b, whereby the at least one element section 162 closest to the road surface 164 is moved radially away from the second central axis b-b in the direction downwards and towards the road surface 164 by means of the cooperation of the first surfaces 146, 150 of the guide members 142, 144, and thus, the studs 112 of the at least one element section 162 are forced towards braking engagement with the road surface 164. When the wheel 116 stops skidding, the element 106 returns to the at least one position of FIGS. 6 and 7.

In FIG. 7, when the wheel 116 rolls without skidding, it is also shown that the guide means are arranged to rotate the element 106 about the first central axis a-a so that the first central axis a-a is eccentric in relation to the second central axis b-b, i.e. they are not collinear, and the element 106 is pushed towards the road surface essentially only by its own weight and is dislocated vertically upwards in relation to the wheel 116. In FIG. 9, when the wheel skids or slides on the road surface, it is evident that the guide means may be arranged to move the element 106 and the first central axis a-a in a direction towards the second central axis b-b so that the first central axis a-a is positioned closer to the second central axis b-b compared to when the wheel rolls without skidding. The harder the wheel 116 is braked the harder the at least one element section 162 is pressed towards the road surface 164.

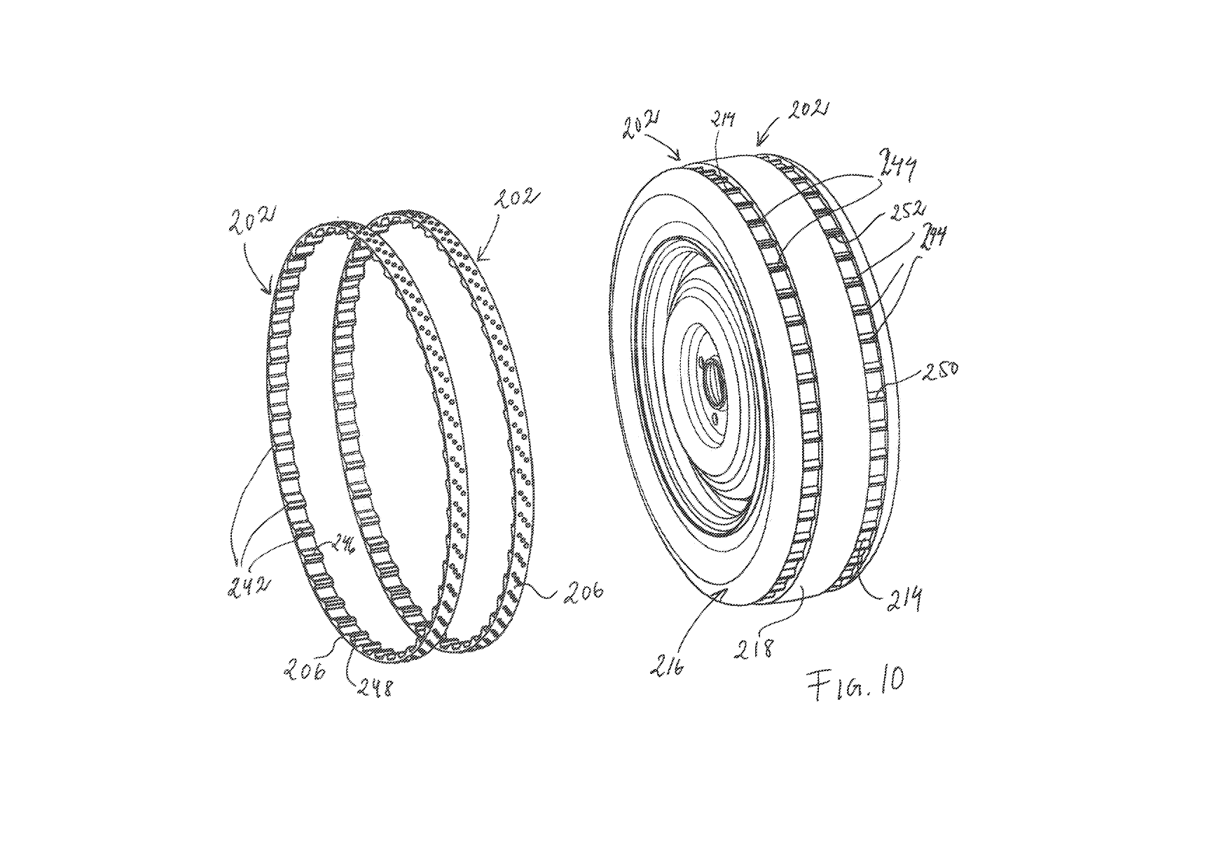

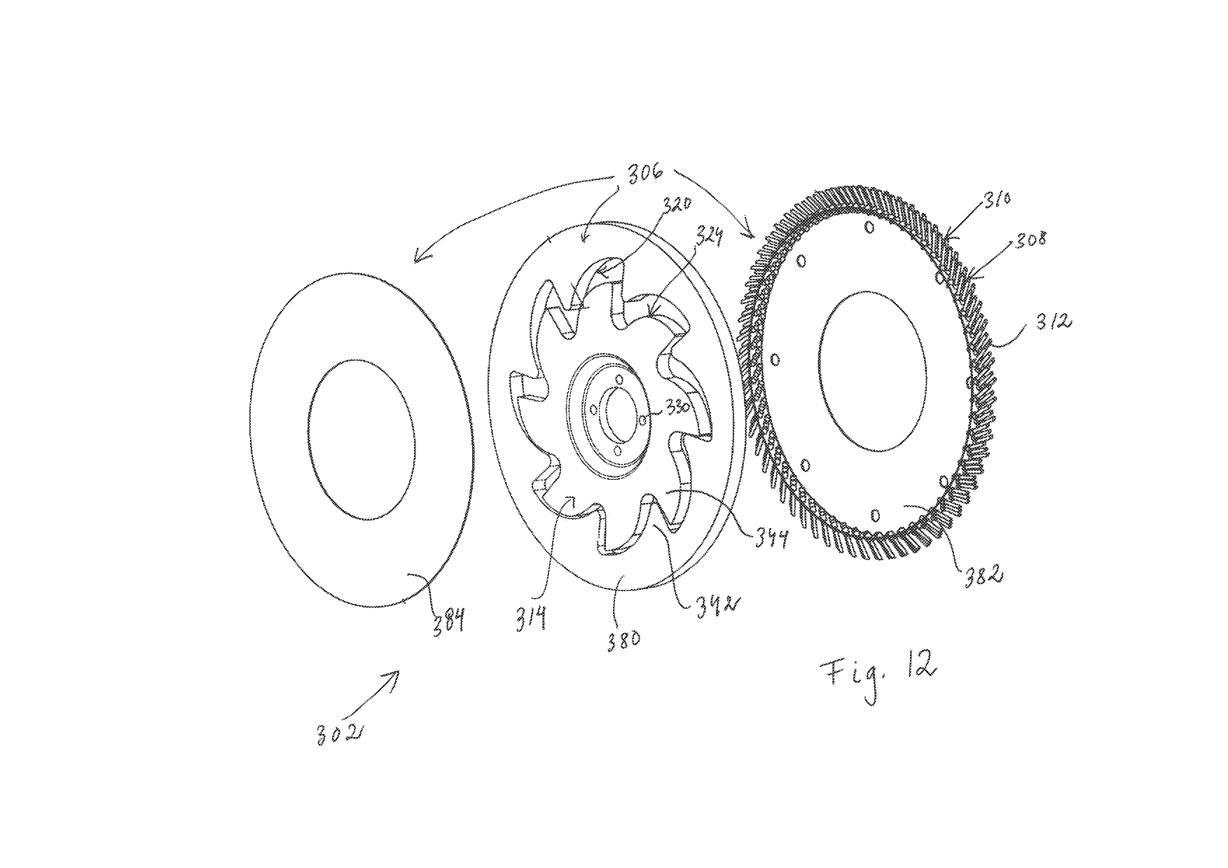

With reference to FIGS. 10-11, a second embodiment of the apparatus 202 according to the present invention is schematically shown, for preventing the skidding or sliding of wheeled vehicle on a road surface. The annular element 206 has essentially the same configuration as the first embodiment 102, but the first guide members 242 have a different design or shape. However, the mounting means 214 differs more from the mounting means 114 of the first embodiment. In the second embodiment, the mounting means 214 is arranged to be provided in a tire 218 which is included in a wheel 216 of the vehicle, and the mounting means 214 may be integral with the tire 218. In the second embodiment, the tire 218 and the mounting means 214 forms the annular grove in which the element 206 is provided and held. The mounting means 214 has corresponding second guide members 244, but with a different shape in relation to the first embodiment. The first and second guide members 242, 244 of each pair cooperate with their respective first and second surfaces 246, 250, 248, 252 in a corresponding manner as in the first embodiment and this is thus not disclosed in more detail. In FIGS. 10 and 11, a wheel 216 is provided with two apparatuses 202, but the wheel may also be provided with only one apparatus 202 or with more than two apparatuses 202.

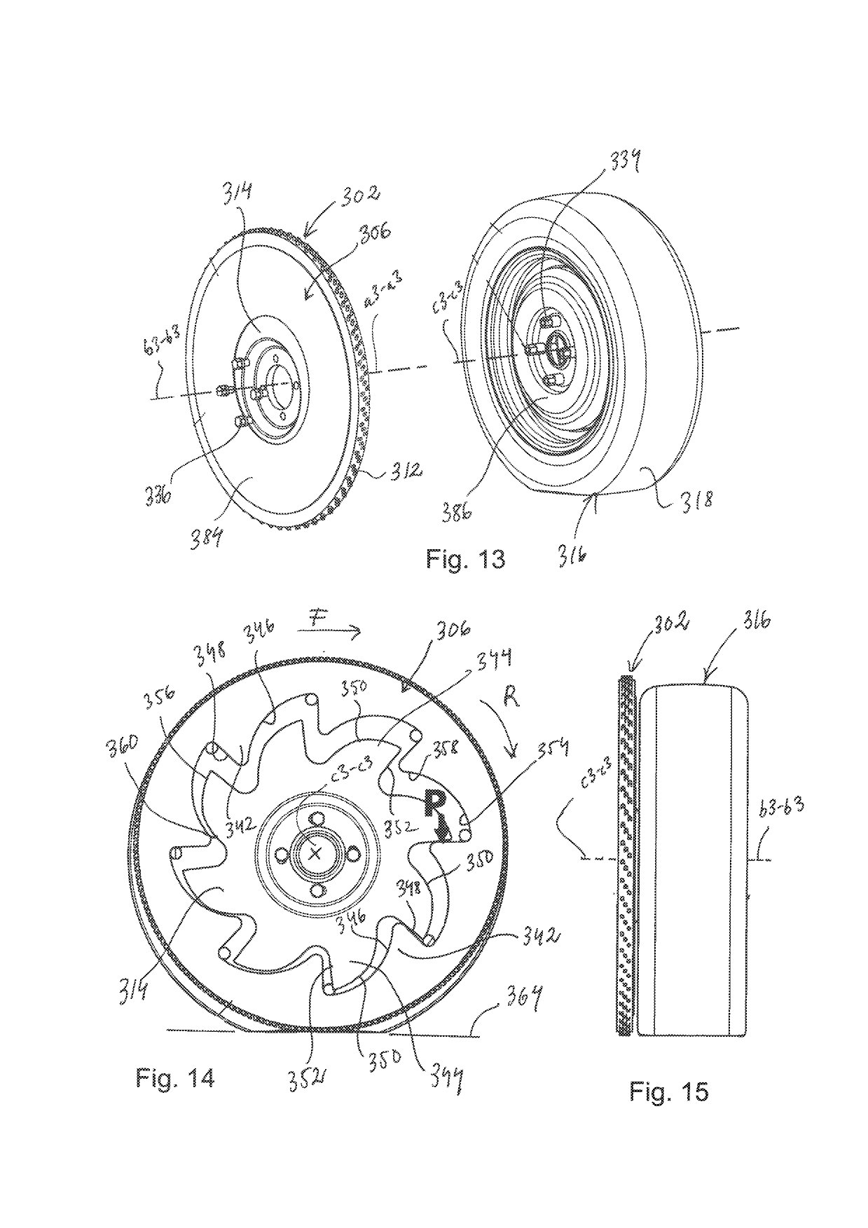

With reference to FIGS. 12-17, a third embodiment of the apparatus 302 according to the present invention is schematically shown, for preventing the skidding or sliding of vehicle having wheels on a road surface 364. The apparatus 302 according to the third embodiment comprises an annular element 306 made of a rigid material, such as hard plastic, rubber or metal. The annular element 306 may for this embodiment be described as an extra wheel. The element 306 defines a first central axis a3-a3 (see FIG. 13) and has an outer wall 308 extending around the first central axis a3-a3 and facing away from the first central axis a3-a3 and being provided with friction means 310 arranged to engage the road surface 364. In this embodiment, the friction means comprise a plurality of elongated studs 312 distributed on the outer wall 308 about the first central axis a3-a3. The studs 312 may be made of metal, hard plastic, or any other suitable material. The element 306 has an inner wall 320 extending around the first central axis a3-a3 and facing the first central axis a3-a3.

The element 306 comprises an annular first element unit 380 provided with the inner wall 320 of the element 306, an annular second element unit 382, provided with the outer wall 308 of the element 306 and the friction means 310, and an annular third element unit 384, which are mounted to one another to at least partially enclose the mounting means 314 disclosed below. When assembled, the element units 380, 382, 384 are not movable in relation to one another.

The apparatus 302 comprises mounting means 314 for mounting the element 306 to one of the rotatable wheels 316 of a vehicle and about a second central axis b3-b3 defined by the mounting means 314 (see FIG. 13). Advantageously, the wheel 316 is provided with a tire 318 arranged to be pressurized and inflated with compressed air or gas in known manners. The mounting means 314 is arranged to be attached to the wheel 316 so that the second central axis b3-b3 is substantially collinear with an axis of rotation c3-c3 defined by the wheel (see FIGS. 13 and 15) and so that the mounting means 314 and the element 306 are rotatable about the axis of rotation c3-c3. The element 306 is pivotable/movable in a direction about the first and second central axes a3-a3, b3-b3 in relation to the mounting means 314.

The mounting means 314 comprises an outer wall 324 extending around the second central axis b3-b3 and facing away from the second central axis c3-c3. The mounting means 314 is attachable to the wheel 316 by means of a plurality of through-holes 330, which may be threaded, provided in the mounting means 314, a plurality of threaded recesses 334 provided in the wheel 316 and a plurality of threaded attachment members 336, e.g. bolts/screws. However, the mounting means 314 may be configured in a plurality of other manners for attachment to the wheel 116. As mentioned above, the mounting means 314 is at least partially enclosed by the element 306. The element 306 defines an annular compartment in which the mounting means 314 is provided, but the central portion of the mounting means 314 is not covered by the element 306.

FIGS. 14-17 show the wheel 316 provided with one mounted apparatus 302, but the wheel may be provided with two apparatuses 302, one at the outside of the wheel 316 and another at the inside of the wheel, The mounting means 314 may be arranged to be attached to the hub 386 of the wheel 316.

The mounting means 314 and the element 306 comprise complementary guide members movable in relation to one another and about the first central axis a3-a3. The guide members comprise a plurality of pairs of guide members 342, 344 distributed about the first and the second central axis a3-a3, b3-b3, respectively. The element 306 is provided with a first guide member 342 of each pair and the mounting means 314 is provided with a second guide member 344 of each pair. The guide members 342, 344 of each pair are arranged to cooperate with one another. The inner wall 320 of the element 306 is provided with the first guide members 342 of each pair, and the outer wall 324 of the mounting means 314 is provided with the second guide members 344 of each pair. Said plurality of pairs of guide members 342, 344 is evenly distributed about the first and the second central axis a3-a3, b3-b3, respectively.

The first guide member 342 of each pair has a first surface 346 which forms at least one first angle with the tangential direction about the first and the second central axis a3-a3, b3-b3, respectively, and forms at least one second angle with the radial direction, where the radial direction is related to the first and the second central axis a3-a3, b3-b3, respectively. The first guide member 342 of each pair has a second surface 348 which extends substantially radially. The second guide member 344 of each pair has a first surface 350 which forms at least one first angle with the tangential direction about the first and the second central axis a3-a3, b3-b3, respectively, and forms at least one second angle with the radial direction. The second guide member 344 of each pair has a second surface 352 which extends substantially radially. Each first surface comprises a first surface portion 354, 356 and a second surface portion 358, 360, where the first surface portion 354 of the first guide member 342 is located further away from the first and the second central axis a3-a3, b3-b3, respectively, in relation to the second surface portion 358 of the first guide member 342. The first surface portion 356 of the second guide member 344 is located further away from the first and the second central axis a3-a3, b3-b3, respectively, in relation to the second surface portion 360 of the second guide member 344.

The first and second guide members 342, 344 of each pair are arranged to cooperate with one another. When the wheel 316 skids or slides on the road surface, the first and second guide members 342, 344 are arranged, by means of the cooperation of the first surfaces 346, 350 of the guide members 342, 344, to move, or dislocate, at least one section 362 of the element 306 closest to the road surface 364 away from the second central axis b3-b3 and thus to drive the studs 312 of the at least one element section 362 towards braking engagement with the road surface 364. The first and second guide members 342, 344 are arranged, by means of the cooperation of the first surfaces 346, 350 of the guide members 342, 344, to radially move, or dislocate, the at least one element section 362 away from the second central axis b3-b3 by moving the at least one element section 362 about the first central axis a3-a3 in relation to the mounting means 314. When the wheel 316 skids or slides on the road surface the first surfaces 346, 350 are arranged to limit the rotation of the element 306 about the first central axis a3-a3. When the wheel 316 rolls on the road surface 364, the first and second guide members 342, 344 are arranged, by means of the cooperation of the second surfaces 348, 352 of the guide members 342, 344, to rotate the element 306 about the first central axis a3-a3. When the wheel 316 rolls on the road surface, the guide means are arranged to rotate the element 306 about the first central axis a3-a3 so that the first central axis a3-a3 is eccentric in relation to the second central axis b3-b3, and when the wheel skids or slides 316 on the road surface, the guide means are arranged to move the element 306 and the first central axis a3-a3 in a direction towards the second central axis b3-b3.

With reference to FIGS. 14-15, the wheel 316 and the apparatus 302 are shown when the wheel 316 rolls on the road surface 364 during normal drive without the wheel 316 skidding or sliding in the direction of travel F of the vehicle. The wheel 316 and the apparatus 302 rotate in the direction of rotation R. As shown in FIG. 14, the second surfaces 143, 352 of the guide members 342, 344 abut one another at the lower portion of the wheel 316 closest to the road surface 364. The second surface 354 of the guide member 344 of the mounting means 314 can be described as forcing or pushing the second surface 348 of the guide member 342 of the element 306. The element 306 has a slightly larger diameter than the wheel 316, and the second surface 352 of the second guide member 344 can be described as “holding back” the second surface 348 of the first guide member 342 and thus holds back the element 306, as the element 306 with its larger diameter than the wheel 316 wants to roll “faster” than the wheel 316. In FIGS. 14 and 15, the element 306 rolls with the studs on the road surface 364 without any braking engagement with the road surface, and the wear on the road surface and on the studs 312 is minimized.

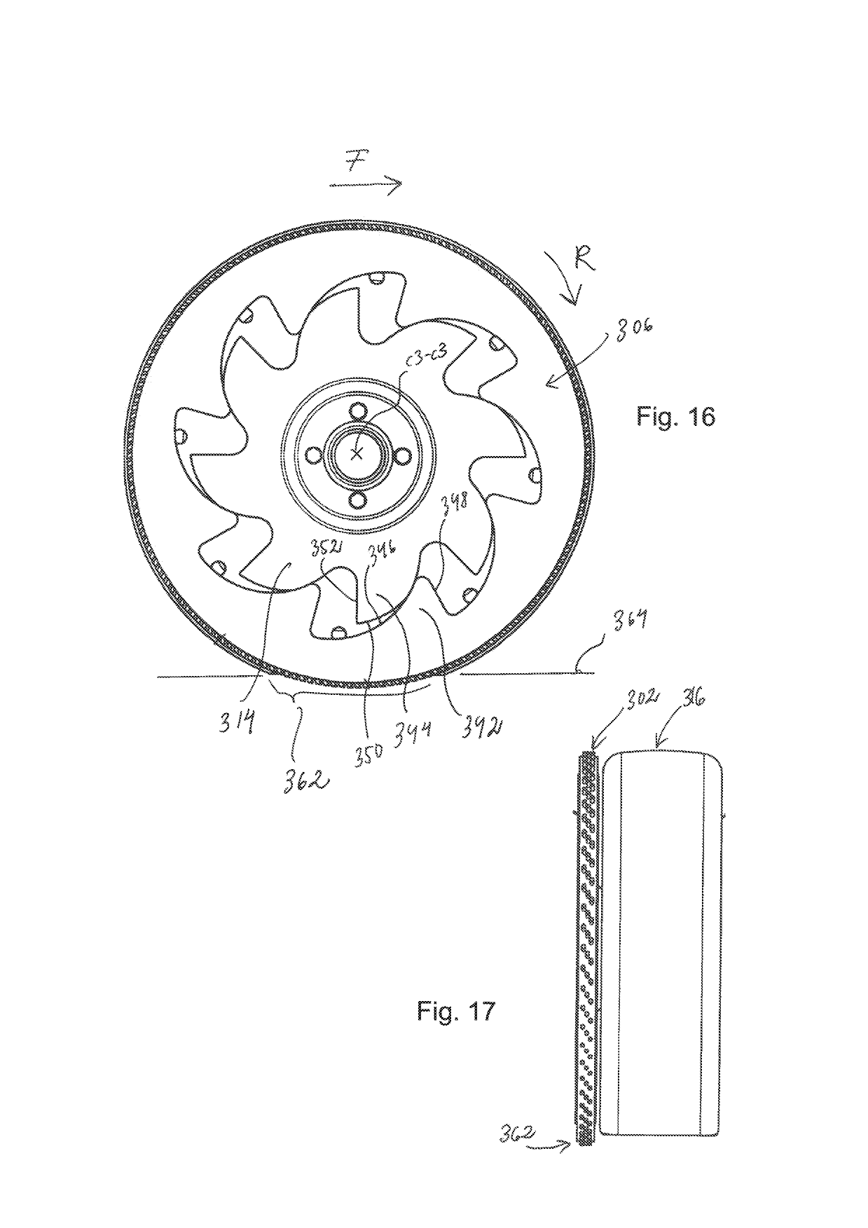

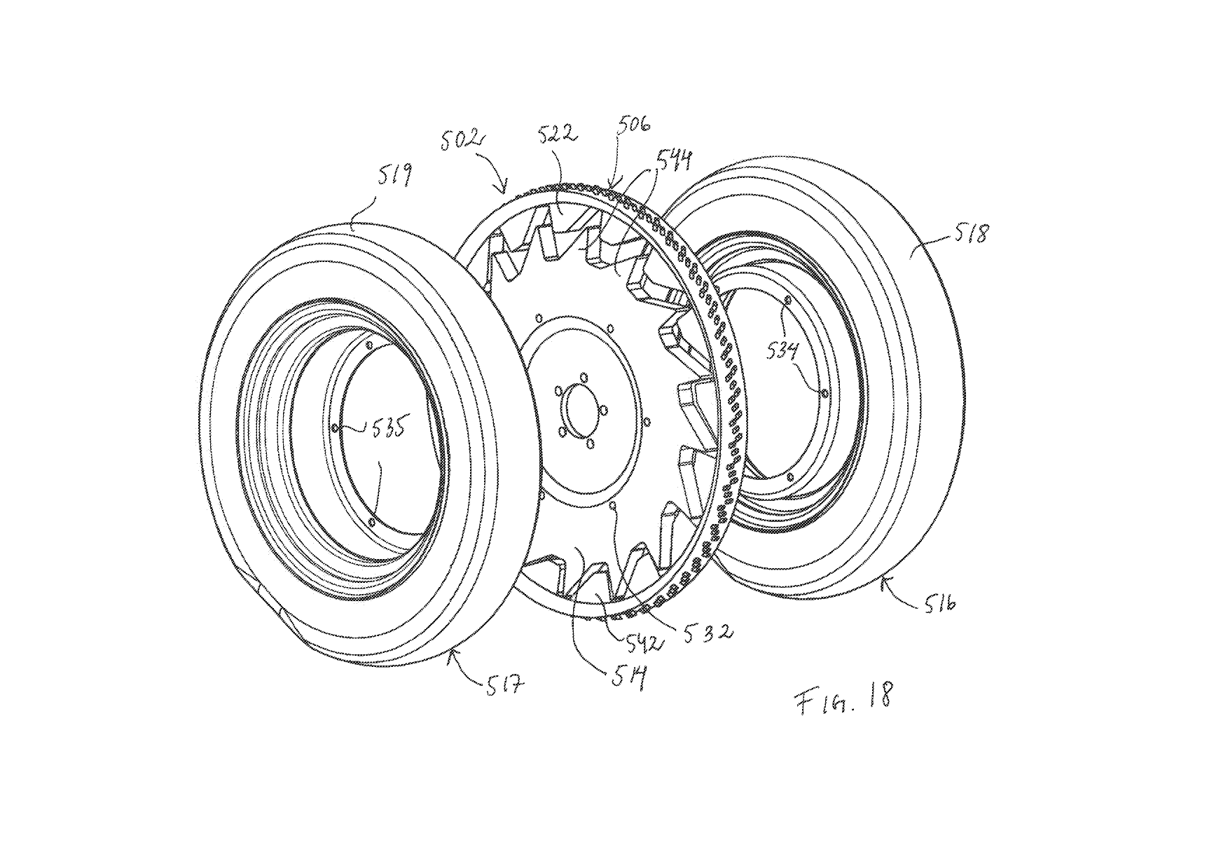

With reference to FIGS. 16-17, the wheel 316 and the apparatus 302 are shown when the wheel 316 skids or slides in the direction of travel F of the vehicle during braking. The movement of the wheel 316 and the mounting means 314 in the direction of rotation R is reduced or completely stops. However, the element 306 has a movement, or a faster movement, in the direction of rotation R, which results in that the first guide member 342 is moved in the direction of rotation R in relation to the second guide member 344. However, closest to the road surface 364, the movement of the first guide members 342 in the direction of rotation R is limited or restricted by means of the cooperation of the first surfaces 346, 350 of the guide members 342, 344. The first surfaces 346, 350 of the guide members 342, 344 distinctly abut one another in FIG. 16. The result is that the first guide members 342 closest to the road surface 364 are moved radially away from the second central axis b3-b3, whereby the at least one element section 362 closest to the road surface 364 is moved radially away from the second central axis b3-b3 in the direction downwards and towards the road surface 364 by means of the cooperation of the first surfaces 346, 350 of the guide members 342, 344, and thus, the studs 312 of the at least one element section 362 are forced towards braking engagement with the road surface 364. When the wheel 316 stops skidding, the element 306 returns to the at least one position of FIGS. 14 and 15. In FIG. 15, when the wheel 316 rolls without skidding, it also shown that the guide means are arranged to rotate the element 306 about the second central axis b3-b3 so that the first central axis a3-a3 is eccentric in relation to the second central axis b3-b3, i.e. they are not collinear, and the element 306 is pushed towards the road surface essentially only by its own weight and is dislocated vertically upwards in relation to the wheel 316. In FIG. 17, when the wheel 316 skids or slides on the road surface, it is evident that the guide means may be arranged to move the element 306 and the first central axis a3-a3 in a direction towards the second central axis b3-b3 so that the first central axis a3-a3 is positioned closer to the second central axis b3-b3 compared to when the wheel rolls 316 without skidding. In alternative wording, the guide means may be arranged to centre the element 306 towards the mounting means 314 when the wheel skids. The harder the wheel 316 is braked the harder the at least one element section 362 is pressed towards the road surface 364.

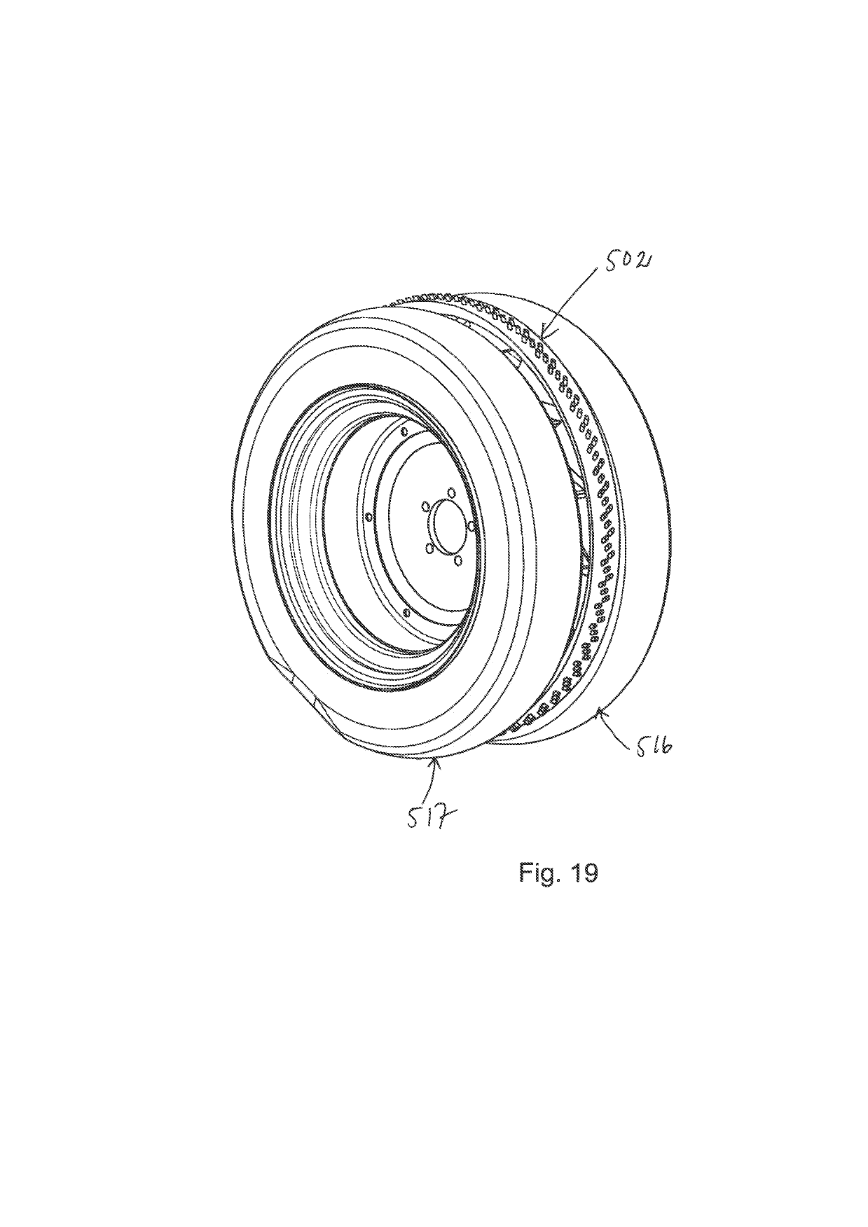

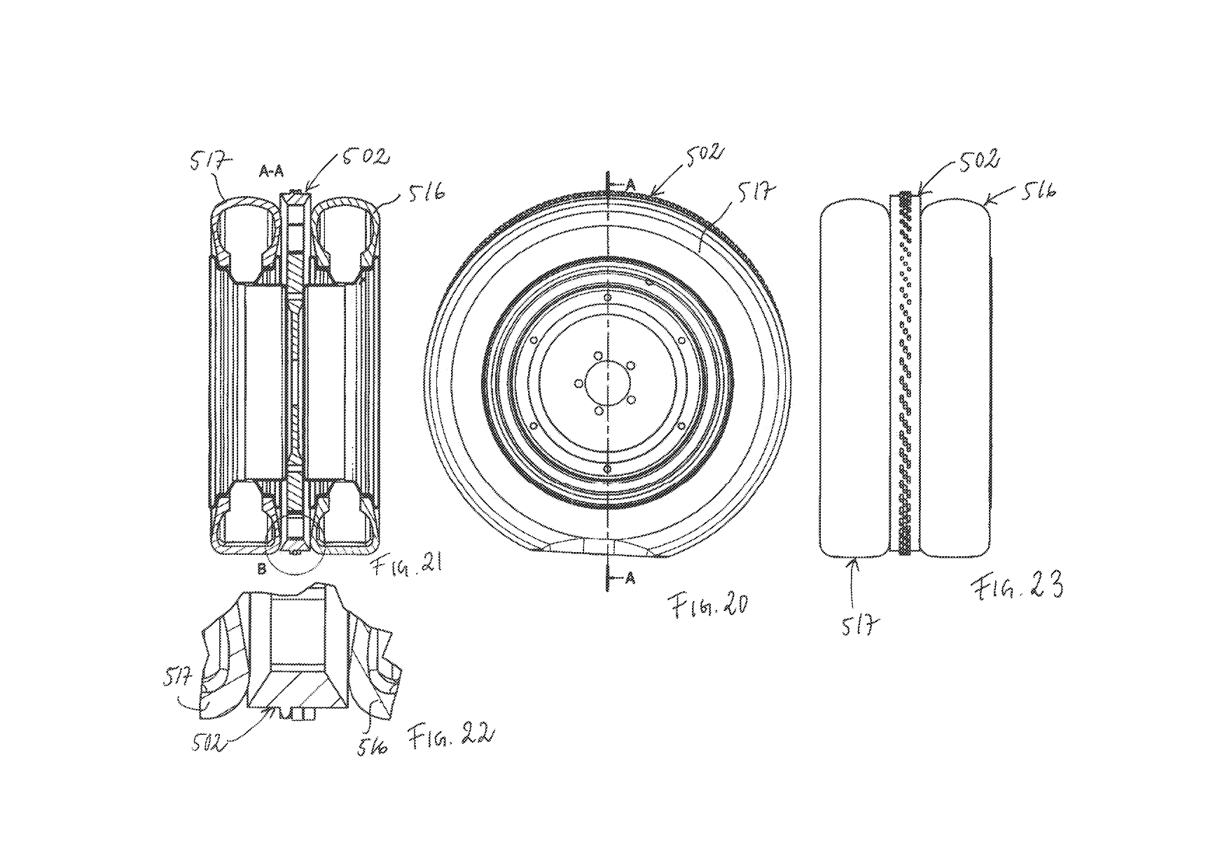

FIG. 18 schematically shows a fourth embodiment of the apparatus according to the present invention which essentially corresponds to the first embodiment of FIGS. 1-9, but with the difference that the mounting means 514 is arranged to mount the element 506 to two adjacent vehicle wheels 516, 517, which in FIG. 18 comprise a tire 518, 519 each. The element 506 of FIG. 18 may correspond to the element 106 of the first embodiment. The mounting means 514 may essentially correspond to the mounting means 114 of the first embodiment but with the difference that the mounting means 514 of FIG. 18 comprises only one mounting unit 522 and not any annular second mounting unit, which is the case for the first embodiment. The mounting means 514, which here is equal to the mounting unit 522, is attachable to the two wheels 516, 517 by means of through-holes 532, which may be threaded, provided in the mounting means 514, a plurality of threaded recesses 534, 535 provided in each wheel 526, 517, e.g. in the rim of the wheel, and a plurality of threaded attachment members (not shown), e.g. bolts/screws. Further, the mounting means 514 and the element 506 may comprise corresponding details which are included in the first embodiment, and may thus comprise first and second guide members 542, 544 cooperating with one another in a corresponding manner as for the first embodiment. FIG. 19 shows the apparatus 502 assembled and mounted to the two vehicle wheels 516, 517. FIG. 20 schematically shows the apparatus 502 and the vehicle wheel 517 as viewed from the side. FIG. 21 shows the section A-A of FIG. 20, FIG. 22 shows an enlargement of the region B of FIG. 21, and FIG. 23 is a schematic front view of the apparatus 502 mounted to the vehicle wheels 516, 517. The fourth embodiment is suitable for heavier vehicles, such as lorries and busses, which may be equipped with double tires. However, the fourth embodiment may be suitable for private cars. The width of the vehicle wheels 516, 517 and their tires 518, 519 may be adapted to the chosen application. The tires 518, 519 of the vehicle wheels 516, 517 do need to have the same width, e.g., but may have different widths, which may be an advantage in order to attain a control which is more well balanced when braking and when the apparatus 502 enters braking engagement with the road surface. If any of the tires 518, 519 of the vehicle wheels 516, 517 would be punctured or explode, the vehicle may still be driven by means of the fourth embodiment. If both tires explode, the apparatus 502 may function as an auxiliary wheel preventing the driver from losing control over the vehicle, and the vehicle may even be driven with reduced speed to a garage or workshop for repair.

In addition to an improvement of existing electronic anti-skid systems as mentioned above, a mechanical anti-skid function, independent of the electronic anti-skid system, may also be built in into the above-mentioned apparatuses. If the element is given a trapezoidal cross-section closest to the outer diameter, an automatic anti-skid function is attained (see FIG. 22). When skidding, such as lateral sliding, the outer wall of the element will be influenced by a lateral force, which results in a force in the same direction but in a direction obliquely downwards towards the road surface when the outer wall of the element is pressed towards to the side of the tire, which in turn results in that the outer wall of the element and its friction means are pushed towards the road surface, whereby the skidding is stopped.

The invention shall not be considered limited to the embodiments illustrated, but can be modified and altered in many within the scope of the appended claims.

1. An apparatus (102; 202; 302) for preventing the skidding or sliding of a wheeled vehicle on a road surface (164), and the apparatus comprises an annular element (106; 206; 306) defining a first central axis (a-a, a3-a3) and having an outer wall (108; 308), the outer wall extending around the first central axis and facing away from the first central axis and being provided with friction means (110; 310) arranged to engage the road surface, and mounting means (114; 214; 314) for mounting the element to one of the rotatable wheels (116; 216; 316) of the vehicle and around a second central axis (b-b, b3-b3) defined by the mounting means, the mounting means being arranged to be attached to the wheel so that the second central axis is substantially collinear with an axis of rotation (c-c; c3-c3) defined by the wheel and so that the mounting means and the element are rotatable, and the element is movable in a direction about the first central axis in relation to the mounting means, characterized in that the mounting means and the element comprise complementary guide means movable in relation to one another, in that, when the wheel skids or slides on the road surface the guide means are arranged to move at least one section (162; 362) of the element away from the second central axis to force the friction means of the at least one element section (162; 362) towards braking engagement with the road surface, and in that, when the wheel rolls on the road surface the guide means are arranged to rotate the element about the first central axis.

2. An apparatus according to claim 1, characterized in that, when the wheel skids or slides on the road surface, the guide means are arranged to limit the rotation of the element about the first central axis.

3. An apparatus according to claim 1 or 2, characterized in that the guide means are arranged to radially move the at least one element section away from the second central axis by moving the at least one element section about the first central axis in relation to the mounting means.

4. An apparatus according to any of the claims 1 to 3, characterized in that the element has an inner wall (120; 320) extending around the first central axis and facing the first central axis, in that the mounting means comprises an outer wall (124; 324) extending around the second central axis and facing away from the second central axis, and in that the outer wall of the mounting means and the inner wall of the element are provided with the guide means.

5. An apparatus according to any of the claims 1 to 4, characterized in that the guide means comprise a plurality of pairs of guide members (142, 144; 342, 344) distributed about the first and the second central axis, respectively, the element being provided with one of the guide members of each pair, and the mounting means being provided with the other guide member of each pair, the guide members of each pair being movable in relation to one another and arranged to cooperate with one another.

6. An apparatus according to claim 5, characterized in that the plurality of pairs of guide members is evenly distributed about the first central axis and the second central axis, respectively.

7. An apparatus according to claim 5 or 6, characterized in that a first guide member (142; 342) of each pair comprises a first surface (146; 346) which forms at least one first angle with the tangential direction about the second central axis and forms at least one second angle with the radial direction.

8. An apparatus according to claim 7, characterized in that a second guide member (144; 344) of each pair comprises a first surface (150; 350) which forms at least one first angle with the tangential direction about the second central axis and forms at least one second angle with the radial direction.

9. An apparatus according to claim 8, characterized in that the first surfaces of a pair's first and second guide members are arranged to cooperate to move the at least one element section away from the second central axis.

10. An apparatus according to any of the claims 5 to 9, characterized in that the first guide member (142; 342) of each pair comprises a second surface (148; 348) which extends substantially radially.

11. An apparatus according to claim 10, characterized in that the second guide member (144; 344) of each pair comprises a second surface (150; 350) which extends substantially radially.

12. An apparatus according to claim 11, characterized in that the second surface of each guide member on the element is arranged to cooperate with the second surface of a guide member on the guiding means to rotate the element about the first central axis.

13. An apparatus according to any of the claims 1 to 12, characterized in that, when the wheel rolls on the road surface the guide means are arranged to rotate the element about the first central axis so that the first central axis is eccentric in relation to the second central axis, and in that, when the wheel skids or slides on the road surface, the guide means are arranged to move the element and the first central axis in a direction towards the second central axis.

14. An apparatus according to any of the claims 1 to 12, characterized in that the mounting means is arranged to be provided in a tire included in the wheel of the vehicle.

15. An apparatus according to claim 14, characterized in that the mounting means is integral with the tire.

16. An apparatus according to any of the claims 1 to 15, characterized in that the friction means comprise studs.

17. An apparatus according to any of the claims 1 to 16, characterized in that the friction means comprise high friction material different from the material of the wheel.

18. A vehicle wheel for the rotatable mounting to a vehicle, the vehicle wheel comprising at least one apparatus for preventing the skidding or sliding of the vehicle on a road surface, characterized in that the apparatus comprises the features according to any of the claims 1 to 17.
